(19) United States
(12) Patent Application Publication
(10) Pub. No.: US 2010/0278890 A1
(43) Pub. Date: Nov. 4, 2010

(54) Use of Lignosulfonates in Suspo-emulsions for Producing Pesticide Compositions

(75) Inventor: Thomas S. Winowiski, Mosinee, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: LIGNOTECH USA, INC., Rothschild, WI (US)

(21) Appl. No.: 12/770,448

(22) Filed: Apr. 29, 2010

Related U.S. Application Data
(60) Provisional application No. 61/173,788, filed on Apr. 29, 2009.

(51) Int. Cl. A01N 25/08; A01N 25/04; A01N 33/02

(52) U.S. Cl. 424/409; 424/405; 514/655

(57) ABSTRACT

Disclosed are compositions and methods related to powder and granular concentrate pesticide formulations. As disclosed, suspo-emulsions comprising pesticide actives may be prepared using a high purity, high molecular weight lignosulfonate as a stabilizer. The resulting suspo-emulsions may then be dried to obtain a powder or granular concentrate where the high molecular weight lignosulfonate acts as a solid matrix for the pesticide actives. The powder or granular concentrate formulations thus formed have high loading rates, good storage properties and are easily reconstituted when added to water.

### CROSS-REFERENCE TO RELATED APPLICATIONS

The present application claims the benefit under 35 U.S.C. §119(e) to U.S. Provisional Patent Application No. 61/173,788, filed on Apr. 29, 2009, the content of which is incorporated herein by reference in its entirety.

### BACKGROUND

The present invention relates to pesticide compositions and methods for producing pesticide compositions. The disclosed compositions may include granular pesticide compositions and powder pesticide compositions which are prepared directly from liquid suspo-emulsions of the pesticide in solutions of lignosulfonate and which in turn may be reconstituted in water into stable emulsions, suspensions, or further suspo-emulsions.

Many pesticides are hydrophobic organic compounds. Some hydrophobic pesticide compounds have a relative low melting point, such that they exist as a liquid at room temperature. Other hydrophobic pesticide compounds having a higher melting point may be dissolved in an organic solvent to obtain a pesticide solution. In order to disperse the pesticide liquid or solution in water for easy application, the pesticide may be formulated as a water-dispersible emulsifiable concentrate. This process typically requires an emulsifying agent, which will cause an emulsion to form spontaneously when the concentrate is added to water.

Processed lignin is obtained as a by-product of wood pulping reactions and has been shown to be useful for a variety of commercial applications. For example, alkali soluble lignin has been used as a dispersing agent. U.S. Pat. No. 3,726,850 discloses the use of an alkali soluble, ozone-treated lignin product, which is essentially free of organically bound sulfur, as a dispersing agent for clays, dyestuffs, pesticides, carbon black and other materials. The '850 patent contrasts the use of alkali soluble, ozone-treated lignin material as dispersing agents with lignosulfonate dispersing agents. Furthermore, the '850 patent does not indicate whether the disclosed formulations are suitable for preparing granular pesticide formulations that may be reconstituted as emulsions, suspension, or suspo-emulsions.

U.S. Pat. No. 4,666,522 discloses the use of lignosulfonate products for preparing emulsions of waxes, oils, fats, asphalts, and mixtures thereof. However, the '522 patent does not disclose the use of high purity, high molecular weight lignosulfonates as emulsifying agents for hydrophobic, low melting point pesticides. Furthermore, the '522 patent indicates that a stable emulsion cannot be prepared unless the lignosulfonate concentration is 45-65%. The '522 patent also does not indicate whether the disclosed formulations are suitable for preparing granular pesticide formulations that may be reconstituted as emulsions, suspension, or suspo-emulsions.

U.S. Pat. No. 5,668,183 discloses the use lignosulfonate products for dispersing fat-soluble substances. However, the '183 patent does not disclose the use of high purity, high molecular weight lignosulfonates as emulsion stabilizers for hydrophobic, low melting point pesticides. The '183 patent indicates that suitable lignosulfonate products consist of 40-90% lignosulfonic acid, or its salts, and include various amounts of hygroscopic agents such as saccharides, ash, carbohydrates, acetates, formates, resins, etc. Lignosulfonate products that have relatively high sugar content also are taught as being suitable for the methods of the '183 patent. The '183 patent does not indicate that high purity lignosulfonates having low sugar content are desirable or even suitable for the disclosed methods. Furthermore, the '183 patent does not indicate whether the disclosed formulations are suitable for preparing granular pesticide formulations that may be reconstituted as emulsions, suspension, or suspo-emulsions.

Safer and more environmentally friendly emulsion and suspension stabilizers and carriers for pesticides are needed. Disclosed herein are high purity, high molecular weight lignosulfonate materials for preparing stable, dispersible pesticide emulsions and suspensions which may be combined to form suspo-emulsions. The prepared suspo-emulsions may be dried or granulated to obtain powder or granular pesticide formulations, which in turn, may be reconstituted with water to obtain stable, dispersible emulsions, suspensions, or further suspo-emulsions. The disclosed pesticide formulations exhibit many desirable characteristics such as stability, flowability, dissolvability, and low hygroscopicity.

### SUMMARY

Disclosed are pesticide compositions and methods for producing pesticide compositions. The disclosed compositions may include granular compositions and powder compositions prepared directly from suspo-emulsions. The granular compositions and powder compositions disclosed herein can be stored for significant periods of time after which they may be reconstituted into stable emulsions, suspension, or further suspo-emulsions for application in the field, yard, or garden.

The disclosed compositions may include granular compositions and powder compositions prepared from a suspo-emulsion made by combining an emulsion and a suspension. The emulsion of the suspo-emulsion may be prepared by combining a non-aqueous based liquid or solvent soluble first pesticide active with an aqueous solution comprising a high purity, high molecular weight lignosulfonate and optionally a wetting agent or diluent such as lactose. The suspension of the suspo-emulsion may be prepared by combining a water-insoluble, solid second pesticide active (e.g., in powder or granular form) with an aqueous solution comprising a high purity, high molecular weight lignosulfonate and optionally a wetting agent or diluent such as lactose. The first pesticide active and second pesticide active may be the same or different (preferably different). The lignosulfonate may stabilize the emulsion and suspension once they have been formed (e.g., as by mechanical shear or ultrasonication). The emulsion and suspension then may be combined or mixed to form the suspo-emulsion. When the suspo-emulsion thereby formed is dried or granulated, the high purity, high molecular weight lignosulfonate may provide an inert, matrix for at least one of the pesticide actives. In some embodiments, the lignin and the solid second pesticide active may provide a stabilizing matrix for the first pesticide active. When the dried or granulated suspo-emulsion is combined with an aqueous solution, the high purity, high molecular weight lignosulfonate may dissolve and further may function as a stabilizer for at least one of the reconstituted pesticide actives (preferably both reconstituted pesticide actives).

In some embodiments, the disclosed compositions may include a dried or granulated suspo-emulsion. The disclosed suspo-emulsion may be prepared by combining or mixing (a) an emulsion of a first pesticide active; and (b) a suspension of a second pesticide active. The emulsion may be prepared by a method that includes: (a) preparing an aqueous lignosulfonate solution by dissolving a lignosulfonate material in water or an aqueous solution, where the lignosulfonate material comprises at least about 90% (w/w) lignosulfonic acid, or its salts, (preferably at least about 95% (w/w) lignosulfonic acid or its salts) and the lignosulfonate has an average molecular weight of about 20 kDa to about 100 kDa (preferably about 40 kDa to about 60 kDa); (b) combining the aqueous lignosulfonate solution with a hydrophobic liquid, where the hydrophobic liquid comprises a first pesticide active or agent (e.g., a first pesticide liquid or a first pesticide compound dissolved in an organic solvent) and forming the emulsion (e.g., by mechanical shear or ultrasonication). Optionally, the emulsion may comprise a wetting agent, lactose, an inorganic salt, or other soluble material that may act as an inert filler. The suspension may be prepared by a method that includes: (a) preparing an aqueous lignosulfonate solution by dissolving a lignosulfonate material in water or an aqueous solution, where the lignosulfonate material comprises at least about 90% (w/w) lignosulfonic acid, or its salts, (preferably at least about 95% (w/w) lignosulfonic acid or its salts) and the lignosulfonate has an average molecular weight of about 20 kDa to about 100 kDa (preferably about 40 kDa to about 60 kDa); and (b) combining the aqueous lignosulfonate solution with a water-insoluble, solid second pesticide active (e.g., in powder or granular form) and forming the suspension (e.g., by mechanical shear or ultrasonication). Optionally, the suspension may comprise a wetting agent, lactose, an inorganic salt, or other soluble material that may act as an inert filler. The formed emulsion and formed suspension then are combined to form the suspo-emulsion. The suspo-emulsion then may be dried to form the pesticide composition by drying methods that include, but are not limited to, air drying, freeze drying, and spray drying (preferably air drying).

The disclosed pesticide compositions may be prepared from an aqueous suspo-emulsion. The aqueous suspo-emulsion may be prepared by mixing an aqueous emulsion and an aqueous suspension. The aqueous emulsion may comprise an active pesticide ingredient directly emulsified in water comprising a dissolved lignosulfonate, or an active pesticide ingredient dissolved in a solvent that is emulsified in water comprising a dissolved lignosulfonate. In some embodiments, the disclosed emulsions comprise no more than about 70% (w/w) water (preferably no more than about 65% (w/w) water, more preferably no more than about 60% (w/w) water, even more preferably no more than about 50% (w/w) water). The aqueous suspension may comprise an active pesticide ingredient in solid particulate form suspended in water comprising a dissolved lignosulfonate. In some embodiments, the disclosed suspensions comprise no more than about 70% (w/w) water (preferably no more than about 65% (w/w) water, more preferably no more than about 60% (w/w) water, even more preferably no more than about 50% (w/w) water).

The disclosed suspo-emulsions typically comprise lignosulfonate material. In some embodiments, the disclosed emulsions comprise no more than about 40% (w/w) of the lignosulfonate material (preferably no more than about 30% of the lignosulfonate material, more preferably no more than about 20% of the lignosulfonate material).

In some embodiments, the disclosed emulsions include hydrophobic liquid droplets or particles having a relatively small size. For example, the disclosed emulsions may have a hydrophobic liquid droplet mean volume diameter of less than about 5 microns (preferably less than about 4 microns, more preferably less than about 3 microns even more preferably less than about 2 microns, 1 micron, or 0.6 microns).

In some embodiments, the disclosed suspensions include solid particles having a relatively small size. For example, the disclosed suspensions may include solid particles having a mean volume diameter of less than about 5 microns (preferably less than about 4 microns, more preferably less than about 3 microns even more preferably less than about 2 microns, 1 micron, or 0.6 microns). In some embodiments, the mean volume diameter of the solid particles is within a range of about 0.5 microns to about 5 microns.

The disclosed dry pesticide compositions may include granules or particles having a relatively small size. In some embodiments, the disclosed dry pesticide compositions comprise granular compositions, powder compositions, or a composition that comprises both granules and powder. Granular compositions may comprise granules having an average diameter of about 1 mm to about 8 mm (e.g., where granules represent at least about 80% of the total mass of the composition, preferably at least about 90% of the total mass of the composition, and more preferably at least about 95% of the total mass of the composition). Powder compositions may comprise solid particles having an average diameter of less than about 1 mm (e.g., where the solid particles represent at least about 80% of the total mass of the composition, preferably at least about 90% of the total mass of the composition, and more preferably at least about 95% of the total mass of the composition).

The disclosed methods for preparing the pesticide compositions may include a drying step (e.g., air drying, spray drying, and freeze drying). The disclosed methods for preparing the pesticide compositions may include a granulating step (e.g., fluid bed granulating).

In some embodiments, the granular pesticide composition or powder pesticide composition as disclosed herein may be combined or reconstituted with an aqueous solution to form an emulsion, suspension, or suspo-emulsion. An emulsion, suspension, or suspo-emulsion thus formed may include hydrophobic liquid droplets or solid particles having a relatively small size. For example, the disclosed reconstituted emulsion, suspension, or suspo-emulsion may include hydrophobic liquid droplets or solid particles having a mean volume diameter of less than about 5 microns (preferably less than about 4 microns, more preferably less than about 3 microns even more preferably less than about 2 microns, 1 micron, or 0.6 microns).

The disclosed compositions and methods may include or utilize a lignosulfonate that comprises sulfonated softwood lignin. The lignosulfonate may be prepared by methods that include acid sulfite pulping and optionally fermentation and optionally filtration to provide high purity, high molecular weight lignosulfonate. Fermentation may be performed to provide lignosulfonate having a low sugar content. Filtration may be performed to provide high molecular weight lignin sulfonate (e.g., filtration through a 20 kDa membrane cut-off filter, preferably through a 30 kDa membrane cut-off filter, more preferably through a 40 kDa membrane cut-off filter, even more preferably through a 50 kDa membrane cut-off filter).

The disclosed compositions and methods typically comprise or utilize high molecular weight softwood lignosulfonate. For example, the disclosed fluid emulsions may comprise about 15% (w/w) to about 35% (w/w) high purity, high molecular weight softwood lignosulfonate. The disclosed compositions also comprise a pesticide active or agent (e.g., as a liquid or compound). In some embodiments, the pesticide composition of the granules or powders may comprise at least about 40% (w/w) pesticide active (preferably at least about 50% (why) pesticide active, more preferably at least about 60% (w/w) pesticide active).

The disclosed compositions and methods may comprise or utilize a pesticide active, which may include an herbicide (such as those classified by the Herbicide Resistance Action Committee (HRAC) or the Weed Science Society of America (WSSA)), an insecticide, or a fungicide. The pesticide active may be a liquid or solution (e.g., a pesticide compound dissolved in a solvent) or a solid particulate form. Typically, the liquid or solution is hydrophobic (e.g., an organic or non-aqueous based liquid or a pesticide compound solubilized in an organic solvent). Typically, the solid particulate form is water insoluble. The pesticide active may include, but is not limited to, an agent selected from the group consisting of a thiocarbamate (e.g., ethyl dipropylthiocarbamate (EPTC); ethyl N,N-diisobutylthiocarbamate (butylate); S-ethyl N-ethylthiocyclohexanecarbamate (cycloate); S-Ethyl N,N-hexamethylenethiocarbamate (molinate); S-propyl dipropylthiocarbamate (vemolate), and mixtures thereof); a haloacetanilide (e.g., 2-Chloro-2′-methyl-6-ethyl-N-ethoxymethylacetanilide (acetocholor); 2-Ethyl-6-methyl-1-N-(2-methoxy-1-methylethyl)chloroacetanilide (metolachlor); 2-Chloro-2′,6′-diethyl-N-(methoxymethyl)acetanilide (alachlor); 2′,6′-Diethyl-N-butoxymethyl-2-chloroacetanilide (butachlor); 2-Chloro-N-isopropylacetanilide (propachlor); and mixtures thereof); a nitroaniline (e.g., 2,6-Dinitro-N,N-dipropyl-4-trifluoromethylaniline (trifluralin); 2,6-Dichloro-4-nitroaniline (dicloran); and mixtures thereof); an organophosphate (e.g., Diethyl 4-nitrophenyl phosphorothionate (parathion); S-(1,2-Di(ethoxycarbonyl)ethyl) dimethyl phosphorothiolothionate (malathion); O-Ethyl S-phenyl ethylphosphonothiolothionate (fonofos); and mixtures thereof); a pyrethroid (e.g., permethrin, lambda-cyhalothrin, deltamethrin, tralomethrin, cypermethrin, tefluthrin, and mixtures thereof); a strobilurin (e.g., azoxystrobin, kresoxim-methyl, picoxystrobin, fluoxastrobin, oryzastrobin, dimoxystrobin, pyraclostrobin, trifloxystrobin, and mixtures thereof); and chlorothalonil, also known as tetrachloroisophthalonitrile (e.g., as sold under the names Bravo®, Echo®, and Daconil®); and mixtures thereof.

Lignosulfonate may function as an inert carrier, binding agent, or disintegrating agent in the disclosed compositions. Optionally, the disclosed compositions may include an additional inert carrier, binding agent, or disintegrating agent. Optionally, the disclosed compositions may include wetting agents or diluents.

### BRIEF DESCRIPTION OF THE FIGURES

FIG. 1 provides a photo of the different pesticide powders after air-drying, freeze drying, and spray drying. Air-dried sample is shown before grinding.

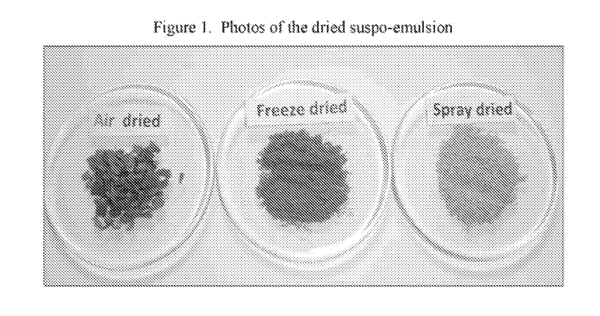

FIG. 2 illustrates backscattered light flux in % as a function of the sample height. The results are plotted on the y-axis as a clear layer in mm. Time in minutes is plotted on the x-axis, and the curves thereby demonstrate the ability of the dried and reconstituted suspo-emulsions to maintain the pesticide in suspension versus the original undried reference sample.

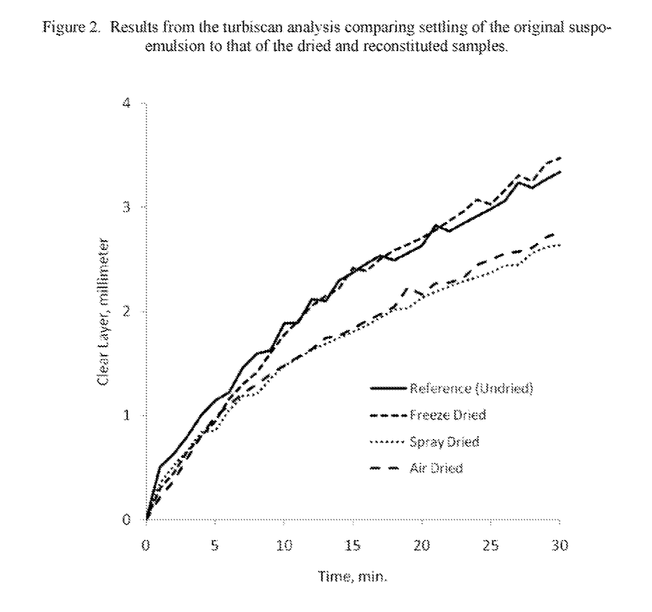

### DETAILED DESCRIPTION

Disclosed are methods for producing pesticide formulations. The disclosed pesticide formulations may be prepared from a non-aqueous based liquid or solvent soluble first pesticide active and a solid particulate second pesticide active using a high purity, high molecular weight lignosulfonate as an emulsion stabilizer and suspension stabilizer for the first and second pesticide active, respectively. The emulsion and suspension thereby formed may be combined to provide a suspo-emulsion. When the suspo-emulsion is dried or granulated, the high purity, high molecular weight lignosulfonate may provide an inert, water soluble matrix for at least one of the first and second pesticide actives. Upon reconstitution, the high purity, high molecular weight lignosulfonate may function as a stabilizer for at least one of the first and second pesticide actives (preferably, as a stabilizer for both the first and second pesticide actives).

Suspo-emulsions of the non-aqueous based liquid or solvent soluble first pesticide active and solid particulate second pesticide active may be reduced to a powder or granular form by any conventional drying or granulating method including but not limited to air drying, spray drying, freeze drying or fluid bed granulation. Preferably, air drying is utilized. In the resulting granules, the high molecular weight lignosulfonate may function as a solid matrix for at/least one of the first or second pesticide active.

The disclosed concentrate formulations thus formed, which may be dry granular concentrate formulations, typically have high loading rates, good storage properties, and good reconstitution properties when added to water. These properties typically are achieved via the use of a high purity, high molecular weight lignosulfonate. The concentrate formulation may be reconstituted to form an emulsion, suspension, or suspo-emulsion. Typically, the reconstituted emulsion, suspension, or suspo-emulsion has a superior stability in comparison to a similar product made with lignosulfonates having lower purity and/or lower molecular weight.

The present invention is described herein using several definitions, as set forth below and throughout the application.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term and “substantially” and “significantly” will mean more than plus or minus 10% of the particular term.

As used herein, the terms “include” and “including” have the same meaning as the terms “comprise” and “comprising.”

As used herein, the term “lignin” has its normal connotation, and refers to an amorphous polymer that occurs in woody material of higher plants such as trees. Lignin is composed of phenylpropanol groups (typically p-phenylpropanol groups) that are linked by various carbon-carbon linkages and ether linkages. Optionally, the phenyl moiety of the phenylpropanol group further is substituted by one or more methoxy groups adjacent to the phenyl moiety's hydroxyl group. The phenylpropanol groups of softwood lignin typically include fewer methoxy substitutions on the phenyl moiety (typically having one or no methoxy substitutions) than phenylpropanol groups of hardwood lignin (typically having two methoxy substitutions).

Lignin typically is recovered from the organosolve process, or from alkaline black pulping liquors such as are produced in the Kraft, soda, and other well known alkaline pulping operations. The term “lignosulfonate” as used in this specification, refers to the product which is obtained by the introduction of sulfonic acid groups into the lignin molecule, as may be accomplished by the reaction of lignin with acid sulfite or bisulfate compounds. For example, the waste liquors from such organosolve or alkaline pulping contain large quantities of lignin and lignin decomposition products, which can be sulfonated or sulfomethylated by known processes, such as high temperature sulfonation, oxidative sulfonation at ambient temperature, or sulfomethylation by reaction of lignin, sodium sulfite and formaldehyde. As used herein, the term “sulfite lignin” refers to the reaction product of lignin, which is inherently obtained during sulfite pulping of wood, straw, corn stalks, bagasse and the like, and is a principle constituent of the spent sulfite liquor which is derived from that process. The phrases “lignosulfonate” and “lignin sulfonate” may be used interchangeably herein and include the sulfonated lignin and sulfite lignin reaction products described above, and also spent sulfite liquors that may be further reacted, purified, fractionated, or the like, as may be required to produce the lignosulfonate material of interest. The lignosulfonates may be utilized in the “as is” or whole liquor condition. They may also be utilized as a purified lignosulfonate material from, or in which the sugars and other saccharide constituents have been removed and/or destroyed, or additionally inorganic constituents have been partially or fully eliminated. Lignosulfonates may be utilized in their salt form. For example, calcium lignosulfonates, sodium lignosulfonates, ammonium lignosulfonates, potassium lignosulfonates, magnesium lignosulfonates and mixtures or blends thereof. Lignosulfonates are available from numerous sources in either solution or dried power forms.

In some embodiments, the above features and advantages may be accomplished by mixing a solution of a high purity, high molecular weight lignosulfonate in water with a non-aqueous based liquid first pesticide active or with a solvent-based solution of a first pesticide active, generating a stable emulsion of the mixture using a high shear mixer. The preparation of emulsions using a high purity, high molecular weight lignosulfonate is disclosed in U.S. Patent Publication No. 2009-0110707, the content of which is incorporated herein by reference in its entirety. In further embodiments, the above features and advantages may be accomplished by mixing a solution of a high purity, high molecular weight lignosulfonate in water with a solid form of a water-insoluble second pesticide active, generating a stable suspension of the mixture using a high shear mixer. The first and second pesticide actives may be the same or different (preferably different). The emulsion and suspension may be combined or mixed to form a suspo-emulsion which subsequently may be dried and granulated via methods that may include tray drying or fluid-bed granulation

In some embodiments, the high purity, high molecular weight lignosulfonate utilized herein may be prepared through the ultrafiltration of lignosulfonates. The preferred ultrafiltration membrane may have a molecular size cut-off of at least about 20 kDa (preferably at least about 50 kDa). Preferably, the lignosulfonates are sulfonated softwood lignin obtained from the sulfite pulping process. Preferably, the lignosulfonates are fermented prior to ultrafiltration.

In some embodiments, the first pesticide active may be a non-aqueous liquid or solution of a water-insoluble active dissolved in a solvent or oil. Suitable solvents include but are not limited to oils, modified oils, petroleum distillates, mineral hydrocarbons, and chlorinated hydrocarbons. As disclosed herein, an “oil” is a hydrocarbon liquid that is not miscible with water. A “modified oil” is an oil that has been altered by fractionation, sulfometholation, hydrogenation, halogenation, or other means to enhance certain end use properties, which may include, but are not limited to flash point temperature, melting temperature, hydrophobicity, and solvent properties. “Petroleum distillates” include petroleum distillation light fractions such as, but not limited to hexane, benzene, toluene, and xylene. “Mineral hydrocarbons” are hydrocarbons derived primarily from inorganic matter such as petroleum and generally are colorless, odorless, and tasteless, which, as disclosed herein, may be used as an adjuvant optionally with a surfactant to be applied in conjunction with a pesticide to improve application, longevity, or efficacy of the pesticide. “Chlorinated hydrocarbons” are hydrocarbons modified by chlorination such that they are nonflammable, noncorrosive, stable liquids, e.g., perchloroethane. “Crop oils” include vegetable oils, which, as disclosed herein, may be used as an adjuvant optionally with a surfactant to be applied in conjunction with a pesticide to improve application, longevity, or efficacy of the pesticide. “Modified crop oils” include liquid hydrocarbons suitable as crop adjuvants that have been modified to enhance or alter certain properties, such as but not limited to flash point temperature, melting temperature, hydrophobicity, and solvent properties (e.g., where methylation of soybean oil may enhance its ability to dissolve waxy plant cuticle).

In some embodiments, the initial emulsion concentrate formulation is prepared by dissolving the high purity, high molecular weight lignin in the aqueous phase of the system. A non-aqueous liquid active or water-insoluble active dissolved in a solvent is then emulsified into the aqueous lignin solution using a high shear emulsifying equipment, such as but not limited to a dispersator, rotor stator, ultrasonic mixer, and high pressure/high shear mixer.

In some embodiments, the initial suspension concentrate formulation is prepared by dissolving the high purity, high molecular weight lignin in the aqueous phase of the system. A water-insoluble solid particulate active is then suspended in the aqueous lignin solution using a high shear emulsifying equipment, such as but not limited to a dispersator, rotor stator, ultrasonic mixer, and high pressure/high shear mixer.

The emulsion and suspension are combined and mixed to form a suspo-emulsion. After the suspo-emulsion is formed, it may be belt-dried and broken into granules and/or it may be granulated using fluid bed technology. In other embodiments, the suspo-emulsion may be dried and/or granulated using procedures that include, but are not limited to air drying, spray drying, drum drying, and freeze drying.

In some embodiments, the suspo-emulsion, which optionally may be dried, may be granulated using wet granulation or dry granulation. Granulation procedures which may be utilized include, but are not limited to shear granulation, high-speed mixer granulation, fluidized-bed granulation, spray drying granulation, spheronizing or pelletizing by extrusion, rotor granulation, dry granulation tableting (e.g., using a slugger), and dry granulation using a roller compactor.

The pesticide compositions disclosed herein may include granule compositions and powder compositions. Typically, the granule compositions disclosed herein comprise granules having an average diameter that is at least about 1 millimeter and optionally no more than about 8 millimeters. The granules may have bulk properties similar to a semi-fluid where they exhibit flow through an orifice that is dependent on the size of the orifice rather than the pressure exerted by overhead material. As used herein, a “powder” is a loose aggregate of discrete particles of a dry material with maximum dimensions of less than 1 mm.

Suspo-emulsions comprising a pesticide active (or a first and second pesticide active as disclosed herein) may be used to prepare dry pesticide compositions having a high loading rate of the pesticide active or actives (e.g., granule compositions and powder compositions). “Loading rate” may be defined as the percentage (w/w) of the active in the final dry pesticide composition. The disclosed granular compositions and powder compositions typically have a high loading rate where levels of the active loading in the granules and powders may be at least about 40%, 50% or 60% (e.g., where the first active is a liquid). For example, granular compositions and powder compositions may be prepared in which the compositions have a loading rate within a range of about 40-50%, 40-60%, 40-70%, 50-60%, 50-70%, or 60-70%. The percentage of pesticide active in a granule composition or powder composition may vary where the pesticide active is present as a percent solution in a suspo-emulsion used to form the granule composition or powder composition. For example, the suspo-emulsion may comprise a first pesticide active as a percent solution of a pesticide compound dissolved in an organic solvent (or optionally as a pesticide liquid mixed with another organic liquid) and a second pesticide active in suspension. In this case, the loading rate will vary based on the concentration of the pesticide active in the percent solution used to form the emulsion and the amount of second pesticide active in suspension.

The disclosed compositions and methods may utilize or include high purity lignosulfonate. As disclosed herein, a “high purity lignosulfonate” is a lignosulfonate in which contaminants such as sugars and phenolic monomers and oligomers (e.g., polymers having fewer than about 10 monomers) have been removed such that at least about 90% of the dry matter is composed of lignosulfonate salt. Optionally, high purity lignosulfonate may be obtained by performing methods that include fermenting and/or ultrafiltering. Purity may be assessed by determining methoxyl content of the lignosulfonate material. In some embodiments, the methoxyl content of lignosulfonate salt may be measured and corrected for the weight of the associated sulfonic groups and salt cation to calculate the purity of the lignosulfonate salt using the typical methoxyl content of lignin in the calculation (e.g., about 14.6% methoxyl content).

The disclosed compositions and methods may utilize or include high molecular weight lignosulfonate. As disclosed herein, a “high molecular weight lignosulfonate” typically has a molecular weight that is greater than about 20 kDa (preferably greater than about 30 kDa, more preferably greater than about 40 kDa, and even more preferably greater than about 50 kDa), which optionally may be determined by size exclusion chromatography (SEC) and/or multi-angle laser light scattering (MALLS).

The disclosed composition and methods may utilize or include pesticide actives. As disclosed herein, a “pesticide active” may include but is not limited to, non-aqueous pesticide liquids or pesticide compounds which optionally are dissolved in non-aqueous solvents (e.g., organic solvents) as a pesticide solution. As disclosed herein, a “pesticide active” may include but is not limited to, a water-insoluble solid pesticide active. Suitable pesticides may include, but are not limited to herbicides (such as those classified by the Herbicide Resistance Action Committee (HRAC) or the Weed Science Society of America (WSSA)), insecticides, and fungicides. Oil-soluble, water-insoluble pesticides may include, but are not limited to thiocarbamate herbicides such as EPTC, butylate, cycloate, molinate, and vemolate; haloacetanilide herbicides such as acetochlor, metoachlor, alachlor, butachlor, and propachlor; nitroaniline herbicides such as trifluralin; organophosphorus insecticides such as parathion, malthion, and fonofos; pyrethroid insecticides such as permethrin, lambda-cyhalothrin, deltamethrin, tralomethrin, cypermethrin, and tefluthrin; and fungicides such as azoxystrobin.

The disclosed pesticide compositions may be made from suspo-emulsions which are prepared by combining an emulsion of a first pesticide active and a suspension of a second pesticide active. The emulsion may be formed by combining aqueous solutions with non-aqueous based liquids or solvent based solutions. As disclosed herein, “non-aqueous based liquids” and “solvent based solutions” include organic, non-polar liquids capable of dissolving organic molecules which are insoluble in water. Examples include, but are not limited to, Aromatic 150, which is a petroleum derived hydrocarbon solvent that may be used to dissolve a solid form of acetochlor or to dilute a liquid form of acetochlor.

The disclosed compositions may include wetting agents, inert fillers, carriers, binding agents, and/or disintegrating agents. Inert carriers include, but are not limited to sugars (e.g., lactose), starch, and kaolin. Inert binders may include, but are not limited to sugars (e.g., lactose), starch, and natural and synthetic gums. Inert disintegrators may include, but are not limited to starch, agar, bentonite, and cellulose.

The disclosed compositions may exhibit desirable properties after storage. For example, granular pesticide composition as disclosed herein may be stored for greater than about 1, 2, or 3 months at a temperature of about 22° C., 40° C., or 45° C. The stored granular pesticide composition may exhibit one or more desirable properties selected from the group consisting of desirable flowability or lack of caking, desirable dispersibility in water or “bloom,” and desirable stability of an emulsion, suspension, or suspo-emulsion formed from the stored granular pesticide composition.

The disclosed compositions may exhibit desirable stability properties. For example, the disclosed compositions may exhibit desirable stability properties after storage (e.g., for a period of time such as 15 minutes, 30 minutes, 1 hour, 2 hours, 4 hours, 8 hours, 1 day, 1 week, 1 month, 2 months, 3 months, 1 year, or longer periods of time). In some embodiments, the disclosed compositions may include emulsions, suspensions, or suspo-emulsions that exhibit desirable stability, for example, where the disclosed emulsions, suspensions, or suspo-emulsions remain uniform and homogeneous without evidence of gravitational separations or particle agglomeration or coalescence after the emulsions, suspensions, or suspo-emulsions is stored for a period of time. The disclosed emulsions, suspensions, or suspo-emulsions also may exhibit desirable stability where the emulsions, suspensions, or suspo-emulsions comprises emulsified oil droplets (i.e., liquid particles) or solid particles that have a size distribution that remains substantially constant after procedures that include drying, storage, and reconstitution. The disclosed compositions may include granules that exhibit desirable stability properties, for example, where after storage the granules remain distinct, separate, and semifluid (i.e., non-agglomerated). The disclosed compositions also may include granules that exhibit desirable stability properties related to chemical properties, for example, where after storage the chemical properties of the granules remain substantially unchanged. In some embodiments, disclosed granules include a surfactant matrix which remains water soluble and capable of stabilizing an emulsion, suspension, or suspo-emulsion after the granules are stored for a period of time.

In further embodiments of the pesticide compositions, the pesticide activity of a pesticide active in a suspo-emulsion composition is not substantially reduced after the suspo-emulsion is dried and reconstituted to form an emulsion, suspension, or further suspo-emulsion. For example, in some embodiments the first or second pesticide active may retain at least about 80% of its pesticide activity after reconstitution (preferably at least about 90% of its pesticide activity after reconstitution, and more preferably at least about 95% of its pesticide activity after reconstitution). In addition, the pesticide activity of the first or second pesticide active in the disclosed compositions may retain at least about 80%, 90%, or preferably 95% of its pesticide activity after storage (e.g., after 1 day, 1 week, 1 month, 3 months, 1 year, or longer) at a selected temperature (e.g., 4° C., 20° C., 22° C., 45° C., or 54° C.). In some embodiments, “pesticide activity” may be measured as the pesticide's effective concentration for killing 50% of a target pest population or EC₅₀.

In even further embodiments, the granules may exhibit reduced hygroscopicity in comparison to granules prepared from lignosulfonates having lower purity and/or lower molecular weight. In still even further embodiments, the granules may exhibit more rapid dissolution in an aqueous solution in comparison to granules prepared from lignosulfonates having lower purity and/or lower molecular weight (e.g., lignosulfonates not subjected to fermentation and/or filtering) and/or from lignosulfonates that are not in a sodium salt form. For example, in some embodiments of the granular compositions, greater than about 95% of the granules are solubilized in water after no more than about 1 minute (preferably greater than about 99% of the granules are solubilized in water after no more than about 1 minute).

The disclosed pesticide compositions may be prepared by first forming a suspo-emulsion (i.e., a “first-formed suspo-emulsion” or a “native suspo-emulsion”) which subsequently is dried. The dried suspo-emulsion preferably is easily reconstituted to form an emulsion, suspension, or further suspo-emulsion (i.e., a “reconstitute”). The first-formed suspo-emulsion and the reconstitute preferably exhibit similar particle size distribution (PSD). For example, in some embodiments, the PSD for the reconstitute (PSD_{rec}) does not vary from the PSD for the first-formed suspo-emulsion (PSD_{ffsc}) by more than 100%, 90%, 80%, 70%, 60%, 50%, 40, 30%, 20%, or 10% (e.g., (|PSD_{rec}−PSD_{ffsc}|)/PSD_{ffsc}≦100%, 90%, 80%, 70%, 60%, 50%, 40, 30%, 20%, or 10%).

### ILLUSTRATIVE EMBODIMENTS

The following embodiments are illustrative and are not intended to limit the disclosed subject matter.

### Embodiment 1

A method for preparing a pesticide composition, the method comprising: (a) preparing an emulsion by steps that include (i) preparing an aqueous lignosulfonate solution by dissolving a lignosulfonate material in water or an aqueous solution, wherein the lignosulfonate material comprises at least about 90% (w/w) lignosulfonate and the lignosulfonate has an average molecular weight of about 20 kDa to about 100 kDa; (ii) combining the aqueous lignosulfonate solution with a hydrophobic liquid, wherein the hydrophobic liquid comprises a first pesticide active or a first pesticide compound dissolved in an organic solvent, and forming an emulsion (e.g., by mechanical shear or ultrasonication); (b) preparing a suspension by steps that include (i) preparing an aqueous lignosulfonate solution by dissolving a lignosulfonate material in water or an aqueous solution, wherein the lignosulfonate material comprises at least about 90% (w/w) lignosulfonate and the lignosulfonate has an average molecular weight of about 20 kDa to about 100 kDa; (ii) combining the aqueous lignosulfonate solution with a solid particulate form of a second pesticide active, and forming a suspension (e.g., by mechanical shear or ultrasonication); (c) combining the emulsion and suspension to form a suspo-emulsion; and (d) drying the suspo-emulsion to form the pesticide composition.

### Embodiment 2

The method of embodiment 1, wherein the emulsion comprises hydrophobic liquid droplets or liquid particles having a hydrophobic liquid droplet mean volume diameter of less than about 5 microns (preferably less than about 4 microns, more preferably less than about 3 microns, even more preferably less than about 2 microns, 1 micron, 0.8 microns, 0.6 microns, or 0.4 microns), and the suspension comprises solid particles having mean volume diameter of less than about 5 microns (preferably less than about 4 microns, more preferably less than about 3 microns, even more preferably less than about 2 microns, 1 micron, 0.8 microns, 0.6 microns, or 0.4 microns).

### Embodiment 3

The method of embodiment 1 or 2, wherein the pesticide composition is a granular composition comprising granules having an average diameter of about 1 mm to about 8 mm.

### Embodiment 4

The method of any of embodiments 1-3, wherein the pesticide composition is a powder composition comprising particles having an average diameter of less than 1 mm.

### Embodiment 5

The method of any of embodiments 1-4, wherein drying is performed by a method selected from the group consisting of air drying, spray drying, and freeze drying.

### Embodiment 6

The method of any of embodiments 1-5, further comprising granulating the pesticide composition to form a granular composition comprising granules having an average particle diameter of about 1 mm to about 8 mm.

### Embodiment 7

The method of embodiment 6, wherein granulating is performed by fluid bed granulating.

### Embodiment 8

The method of any of embodiments 1-7, further comprising: (d) combining the pesticide composition with a second aqueous solution or water to form a further emulsion, suspension, or suspo-emulsion (optionally, wherein the PSD for the reconstitute (PSD_{rec}) does not vary from the PSD for the first-formed suspo-emulsion (PSD_{ffsc}) by more than 100%, 90%, 80%, 70%, 60%, 50%, 40, 30%, 20%, or 10% (e.g., (|PSD_{rec}−PSD_{ffsc}|)/PSD_{ffsc}≦100%, 90%, 80%, 70%, 60%, 50%, 40, 30%, 20%, or 10%))).

### Embodiment 9

The method of embodiment 8, wherein the further emulsion, suspension, or suspo-emulsion comprises hydrophobic droplets or liquid particles having a mean volume diameter of less than about 5 microns (preferably less than about 4 microns, more preferably less than about 3 microns, even more preferably less than about 2 microns, 1 micron, 0.8 microns, 0.6 microns, or 0.4 microns); or the further emulsion, suspension, or suspo-emulsion comprises solid particles having a mean volume diameter of less than about 5 microns (preferably less than about 4 microns, more preferably less than about 3 microns, even more preferably less than about 2 microns, 1 micron, 0.8 microns, 0.6 microns, or 0.4 microns).

### Embodiment 10

The method of any of embodiments 1-9, wherein the lignosulfonate comprises sulfonated softwood lignin.

### Embodiment 11

The method of any of embodiments 1-10, wherein the lignosulfonate material comprises at least about 95% (w/w) lignosulfonate.

### Embodiment 12

The method of any of embodiments 1-11, wherein the lignosulfonate has an average molecular weight of about 40 kDa to about 60 kDa.

### Embodiment 13

The method of any of embodiments 1-12, wherein the suspo-emulsion comprises no more than about 40% (w/w) lignosulfonate.

### Embodiment 14

The method of any of embodiments 1-13, wherein the dry pesticide composition comprises at least about 20%, 40%, or 60% (w/w) of the first and second pesticide active.

### Embodiment 15

The method of any of embodiments 1-14, wherein the first or second pesticide active or compound comprises an agent from the group consisting of a thiocarbamate, a haloacetanilide, a nitroaniline, an organophosphorus, a pyrethroid, a strobilurin, chlorothalonil, and mixtures thereof.

### Embodiment 16

The method of embodiment 15, wherein the thiocarbamate is selected from the group consisting of ethyl dipropylthiocarbamate (EPTC); ethyl N,N-diisobutylthiocarbamate (butylate); S-ethyl N-ethylthiocyclohexanecarbamate (cycloate); S-Ethyl N,N-hexamethylenethiocarbamate (molinate); S-propyl dipropylthiocarbamate (vemolate); and mixtures thereof.

### Embodiment 17

The method of embodiment 15, wherein the haloacetanilide is selected from the group consisting of 2-Chloro-2′-methyl-6-ethyl-N-ethoxymethylacetanilide (acetocholor); 2-Ethyl-6-methyl-1-N-(2-methoxy-1-methylethyl)chloroacetanilide (metolachlor); 2-Chloro-2′,6′-diethyl-N-(methoxymethyl)acetanilide (alachlor); 2′,6′-Diethyl-N-butoxymethyl-2-chloroacetanilide (butachlor); 2-Chloro-N-isopropylacetanilide (propachlor); and mixtures thereof.

Embodiment 18. The method of embodiment 15, wherein the nitroaniline is selected from the group consisting of 2,6-Dinitro-N,N-dipropyl-4-trifluoromethylaniline (trifluralin); 2,6-Dichloro-4-nitroaniline (dicloran); and mixtures thereof.

### Embodiment 19

The method of embodiment 15, wherein the organophosphate is selected from the group consisting of Diethyl 4-nitrophenyl phosphorothionate (parathion); S-(1,2-Di(ethoxycarbonyl)ethyl) dimethyl phosphorothiolothionate (malathion); O-Ethyl S-phenyl ethylphosphonothiolothionate (fonofos); and mixtures thereof.

### Embodiment 20

The method of embodiment 15, wherein the pyrethroid is selected from the group consisting of permethrin, lambda-cyhalothrin, deltamethrin, tralomethrin, cypermethrin, tefluthrin, and mixtures thereof.

### Embodiment 21

The method of embodiment 15, wherein the strobilurin is selected from the group consisting of azoxystrobin, kresoxim-methyl, picoxystrobin, fluoxastrobin, oryzastrobin, dimoxystrobin, pyraclostrobin, trifloxystrobin, and mixtures thereof.

### Embodiment 22

A pesticide composition prepared by the method of any of embodiments 1-21.

### Embodiment 23

A method for preparing a granular pesticide composition,

the method comprising: (a) preparing an emulsion by steps that include (i) preparing an aqueous lignosulfonate solution by dissolving a lignosulfonate material in water or an aqueous solution, wherein the lignosulfonate material comprises at least about 90% (w/w) lignosulfonate and the lignosulfonate has an average molecular weight of about 20 kDa to about 100 kDa; and (ii) combining the aqueous lignosulfonate solution with a hydrophobic liquid, wherein the hydrophobic liquid comprises a first pesticide active or a first pesticide compound dissolved in an organic solvent, and forming an emulsion (e.g., by mechanical shear or ultrasonication); (b) preparing a suspension by steps that include (i) preparing an aqueous lignosulfonate solution by dissolving a lignosulfonate material in water or an aqueous solution, wherein the lignosulfonate material comprises at least about 90% (w/w) lignosulfonate and the lignosulfonate has an average molecular weight of about 20 kDa to about 100 kDa; and (ii) combining the aqueous lignosulfonate solution with a solid particulate form of a second pesticide active, and forming a suspension (e.g., by mechanical shear or ultrasonication); (c) combining the emulsion and suspension (e.g., by mechanical shear or ultrasonication) to form a suspo-emulsion; and (d) granulating the suspo-emulsion to obtain the granule pesticide composition, wherein the composition comprises granules having an average particle diameter of about 1 mm to about 8 mm.

### Embodiment 24

The method of embodiment 23, wherein the lignosulfonate comprises sulfonated softwood lignin.

### Embodiment 25

The method of embodiment 23 or 24, wherein the lignosulfonate material comprises at least about 95% (w/w) lignosulfonate.

### Embodiment 26

The method of any of embodiments 23-25, wherein the lignosulfonate has an average molecular weight of about 40 kDa to about 60 kDa.

### Embodiment 27

The method of any of embodiments 23-26, wherein the granules comprise at least about 40%, 50%, or 60% (w/w) pesticide active (e.g., 40-50%, 40-60%, 40-70%, 50-60%, 50-70%, or 60-70%).

### Embodiment 28

The method of any of embodiments 23-27, wherein the first or second pesticide active comprises an agent selected from the group consisting of a thiocarbamate, a haloacetanilide, a nitroaniline, an organophosphorus, a pyrethroid, a strobilurin, and mixtures thereof.

### Embodiment 29

The method of embodiment 28, wherein the thiocarbamate is selected from the group consisting of ethyl dipropylthiocarbamate (EPTC); ethyl N,N-diisobutylthiocarbamate (butylate); S-ethyl N-ethylthiocyclohexanecarbamate (cycloate); S-Ethyl N,N-hexamethylenethiocarbamate (molinate); S-propyl dipropylthiocarbamate (vemolate); and mixtures thereof.

### Embodiment 30

The method of embodiment 28, wherein the haloacetanilide is selected from the group consisting of 2-Chloro-2′-methyl-6-ethyl-N-ethoxymethylacetanilide (acetocholor); 2-Ethyl-6-methyl-1-N-(2-methoxy-1-methylethyl)chloroacetanilide (metolachlor); 2-Chloro-2′,6′-diethyl-N-(methoxymethyl)acetanilide (alachlor); 2′,6′-Diethyl-N-butoxymethyl-2-chloroacetanilide (butachlor); 2-Chloro-N-isopropylacetanilide (propachlor); and mixtures thereof.

### Embodiment 31

The method of embodiment 28, wherein the nitroaniline is selected from the group consisting of 2,6-Dinitro-N,N-dipropyl-4-trifluoromethylaniline (trifluralin); 2,6-Dichloro-4-nitroaniline (dicloran); and mixtures thereof.

### Embodiment 32

The method of embodiment 28, wherein the organophosphorus is selected from the group consisting of Diethyl 4-nitrophenyl phosphorothionate (parathion); S-(1,2-Di(ethoxycarbonyl)ethyl) dimethyl phosphorothiolothionate (malathion); O-Ethyl S-phenyl ethylphosphonothiolothionate (fonofos); and mixtures thereof.

### Embodiment 33

The method of embodiment 28, wherein the pyrethroid is selected from the group consisting of permethrin, lambda-cyhalothrin, deltamethrin, tralomethrin, cypermethrin, tefluthrin, and mixtures thereof.

### Embodiment 34

The method of embodiment 28, wherein the strobilurin is selected from the group consisting of azoxystrobin, kresoxim-methyl, picoxystrobin, fluoxastrobin, oryzastrobin, dimoxystrobin, pyraclostrobin, trifloxystrobin, and mixtures thereof.

### Embodiment 35

A granular pesticide composition prepared by the method of any of embodiments 23-34.

### Embodiment 36

A pesticide composition prepared from a suspo-emulsion comprising: (a) 15-75% (w/w) water (or 35-70% or 40-60% (w/w) water); (b) 15-40% (w/w) lignosulfonate material (or 15-30% lignosulfonate material), wherein the lignosulfonate material comprises at least about 90% (w/w) softwood lignosulfonate having an average molecular weight of about 40 kDa to about 60 kDa; and (c) 15-45% (w/w) of a first and second pesticide active (or 20-40% w/w) of a first and second pesticide active); wherein the first pesticide active is a hydrophobic liquid and the second pesticide active is a solid particulate form; wherein the suspo-emulsion comprises hydrophobic droplets or solid particles having a mean volume diameter of less than about 5 microns (preferably less than about 4 microns, more preferably less than about 3 microns, even more preferably less than about 2 microns, 1 micron, 0.8 microns, 0.6 microns, or 0.4 microns).

### Example

The following example is illustrative and is not intended to limit the disclosed subject matter.

Preparation of a Dried Suspo-Emulsion

Introduction

Modern pesticides are complex mixtures, containing several components; the most important of which is the active ingredient. There are several types of pesticide formulation currently in production (e.g., Wettable powders, Granules, Suspensions, and Emulsions). A complex system is known as a “suspo-emulsion.” A suspo-emulsion includes solid particles suspended in an emulsion system. This type of system provides the opportunity to have a formulation with multiple active ingredients. Drying of the suspo-emulsion is a further step. Here, lignosulfonate is shown to be a superior additive for this type of formulation.

### EXPERIMENTAL

Preparing of the emulsion. 60 g sunflower oil (24% w/w)+40 g UNA (16.0% w/w)+128 g water (60.0% w/w) were mixed in a glass beaker and sheared in an Ultraturrax® mixer (5 min at 13500 rpm) and then homogenized 2 pass at 250/50 bar.

Preparing of the suspension. 75 g chlorothalonil (30% w/w)+50 g UNA (20.0% w/w)+125 g water (50.0% w/w) were mixed in a glass beaker. Due to wetting problems, 0.5% wetting agent was added (Supragil® brand WP) on weight chlorothalonil. After preparation the PSD (particle size distribution) was measured and the emulsion and suspension were mixed together to form a suspo-emulsion.

The suspo-emulsion was split in four parts. One sample was used as reference, the other three were 1) Spray dried 125/80° C. 2) Freeze dried −57° C. and 3) Air dried overnight at ambient temperature combined with one hour at 50° C. The air dried sample was ground to lower particle size and sieved between 250-600 microns. All samples were measured on PSD after being redispersed in ionized water.

To measure the ability to redisperse a quick test was made with a 100 ml cylinder mixed with 1 g powder dissolved in 100 ml ionized water. The number of inversions was counted to see how quick the powder dissolved.

Measurement in a Turbiscan® instrument was done by dissolving 1 g in 99 g ionized water. Sedimentation was measured every minute for 30 minutes by means of delta-back-scattering (dBS) of light.

TABLE 1
Samples used in the experimental work.

| Name/Description | Remarks |
|---|---|
| Sun Flower oil | Edorado(Kiwi store) |
| Chlorothalonil | 50583 A/5 Jet milled Alpine |
| UNA | 590529 |
| Supragil WP | Rhodia SP151 10.11.2003 |

TABLE 2
Equipment used in the experimental work.

| Equipment | Description |
|---|---|
| HPH | High pressure homogenizer |
| Spray drier | Büchi mini lab |
| Freeze drier | Medinor |
| Heating oven | Termax |
| Ultra turrax T 25 | IKA |

TABLE 3
Results of the PSD

| Sample | PSD-Microns MV |
|---|---|
| Native suspension | 1.9 |
| Native emulsion | 0.8 |
| Native suspo-emulsion | 2.9 |
| Spray dried suspo-emulsion | 2.9 |
| Freeze dried suspo-emulsion | 2.2 |
| Air dried suspo-emulsion | 1.9 |

TABLE 4
Results of the redispersibility.

| Sample | Redispersibility-no of inversions |
|---|---|
| Spray dried suspo-emulsion | 12 |
| Freeze dried suspo-emulsion | 3 |
| Air dried suspo-emulsion | 7 |

The variations of PSD for the different dry samples are shown in Table 3. The sample of the air dried suspo-emulsion was the only sample that visual differed from the other two. This sample appeared to contain some free oil on the surface. The results of the redispersibility seemed to be best for the freeze-dried sample.

### CONCLUSION

Lignosulfonate has been shown to perform well as an additive both in a suspension and emulsion matrix to create a suspo-emulsion, which subsequently can be dried and reconstituted.

1. A method for preparing a pesticide composition, the method comprising:
(a) preparing an emulsion by a method comprising:
(i) preparing an aqueous lignosulfonate solution by dissolving a lignosulfonate material in water or an aqueous solution, wherein the lignosulfonate material comprises at least about 90% (w/w) lignosulfonate and the lignosulfonate has an average molecular weight of about 20 kDa to about 100 kDa;
(ii) combining the aqueous lignosulfonate solution with a hydrophobic liquid, wherein the hydrophobic liquid comprises a first pesticide active, and forming an emulsion; and
(b) preparing a suspension by a method comprising:
(i) preparing an aqueous lignosulfonate solution by dissolving a lignosulfonate material in water or an aqueous solution, wherein the lignosulfonate material comprises at least about 90% (w/w) lignosulfonate and the lignosulfonate has an average molecular weight of about 20 kDa to about 100 kDa;
(ii) combining the aqueous lignosulfonate solution with a solid particulate form of a second pesticide active, and forming a suspension; and
(c) combining the emulsion and suspension to form a suspo-emulsion; and
(d) drying the suspo-emulsion to form the pesticide composition.

2. The method of claim 1, wherein forming the suspo-emulsion comprises, subjecting the combined emulsion and suspension to mechanical shear.

3. The method of claim 1, wherein the hydrophobic liquid comprises a pesticide compound dissolved in an organic solvent.

4. The method of claim 1, wherein the emulsion comprises hydrophobic droplets or liquid particles having a mean volume diameter of less than about 5 microns, and the suspension comprises solid particles having a mean volume diameter of less than about 5 microns

5. The method of claim 1, wherein the pesticide composition is a granular composition comprising granules having an average diameter of about 1 mm to about 8 mm.

6. The method of claim 1, wherein the pesticide composition is a powder composition comprising particles having an average diameter of less than 1 mm.

7. The method of claim 1, further comprising granulating the pesticide composition to form a granular composition comprising granules having an average particle diameter of about 1 mm to about 8 mm.

8. The method of claim 1, further comprising:
(d) combining the pesticide composition with water or a second aqueous solution to form a second emulsion, suspension, or suspo-emulsion.

9. The method of claim 8, wherein the second emulsion, suspension, or suspo-emulsion comprises hydrophobic droplets or liquid particles having a mean volume diameter of less than about 5 microns or solid particles having a mean volume diameter of less than about 5 microns.

10. The method of claim 1, wherein the lignosulfonate comprises sulfonated softwood lignin.

11. The method of claim 1, wherein the lignosulfonate material comprises at least about 95% (w/w) lignosulfonate.

12. The method of claim 1, wherein the lignosulfonate has an average molecular weight of about 40 kDa to about 60 kDa.

13. The method of claim 1, wherein the emulsion comprises about 15% (w/w) lignosulfonate to about 35% (w/w) lignosulfonate.

14. The method of claim 1, wherein the dry pesticide composition comprises at least about 20% (w/w) of the first and second pesticide active.

15. The method of claim 1, wherein the first or second pesticide active comprises an agent selected from the group consisting of a thiocarbamate, a haloacetanilide, a nitroaniline, an organophosphate, a pyrethroid, a strobilurin, chlorothalonil, and mixtures thereof.

16. The method of claim 15, wherein the thiocarbamate is selected from the group consisting of ethyl dipropylthiocarbamate (EPTC); ethyl N,N-diisobutylthiocarbamate (butylate); S-ethyl N-ethylthiocyclohexanecarbamate (cycloate); S-Ethyl N,N-hexamethylenethiocarbamate (molinate); S-propyl dipropylthiocarbamate (vemolate); and mixtures thereof.

17. The method of claim 15, wherein the haloacetanilide is selected from the group consisting of 2-Chloro-2′-methyl-6-ethyl-N-ethoxymethylacetanilide (acetocholor); 2-Ethyl-6-methyl-1-N-(2-methoxy-1-methylethyl)chloroacetanilide (metolachlor); 2-Chloro-2′,6′-diethyl-N-(methoxymethyl)acetanilide (alachlor); 2′,6′-Diethyl-N-butoxymethyl-2-chloroacetanilide (butachlor); 2-Chloro-N-isopropylacetanilide (propachlor); and mixtures thereof.

18. The method of claim 15, wherein the nitroaniline is selected from the group consisting of 2,6-Dinitro-N,N-dipropyl-4-trifluoromethylaniline (trifluralin); 2,6-Dichloro-4-nitroaniline (dicloran); and mixtures thereof.

19. The method of claim 15, wherein the organophosphate is selected from the group consisting of Diethyl 4-nitrophenyl phosphorothionate (parathion); S-(1,2-Di(ethoxycarbonyl)ethyl) dimethyl phosphorothiolothionate (malathion); O-Ethyl S-phenyl ethylphosphonothiolothionate (fonofos); and mixtures thereof.

20. The method of claim 15, wherein the pyrethroid is selected from the group consisting of permethrin, lambda-cyhalothrin, deltamethrin, tralomethrin, cypermethrin, tefluthrin, and mixtures thereof.

21. The method of claim 15, wherein the strobilurin is selected from the group consisting of azoxystrobin, kresoxim-methyl, picoxystrobin, fluoxastrobin, oryzastrobin, dimoxystrobin, pyraclostrobin, trifloxystrobin, and mixtures thereof.

22. A method for preparing a granular pesticide composition, the method comprising:
(a) preparing an emulsion by a method comprising:
(i) preparing an aqueous lignosulfonate solution by dissolving a lignosulfonate material in water or an aqueous solution, wherein the lignosulfonate material comprises at least about 90% (w/w) lignosulfonate and the lignosulfonate has an average molecular weight of about 40 kDa to about 60 kDa;
(ii) combining the aqueous lignosulfonate solution with a hydrophobic liquid, wherein the hydrophobic liquid comprises a first pesticide active, and forming an emulsion; and
(b) preparing a suspension by a method comprising:
(i) preparing an aqueous lignosulfonate solution by dissolving a lignosulfonate material in water or an aqueous solution, wherein the lignosulfonate material comprises at least about 90% (w/w) lignosulfonate and the lignosulfonate has an average molecular weight of about 40 kDa to about 60 kDa;
(ii) combining the aqueous lignosulfonate solution with a solid particulate form of a second pesticide active, and forming a suspension; and
(c) combining the emulsion and suspension to form a suspo-emulsion; and
(d) granulating the suspo-emulsion to obtain the granule pesticide composition, wherein the composition comprises granules having an average particle diameter of about 1 mm to about 8 mm.

23. The method of claim 22, wherein forming the suspo-emulsion comprises subjecting the combined emulsion and suspension to mechanical shear.

24. A granular pesticide composition prepared by the method of claim 1 or claim 22.

25. A suspo-emulsion comprising:
(a) water;
(b) lignosulfonate material, wherein the lignosulfonate material comprises at least about 90% (w/w) softwood lignosulfonate having an average molecular weight of about 40 kDa to about 60 kDa; and
(c) a first pesticide active, wherein the first pesticide active is a hydrophobic liquid; and
(d) a second pesticide active, wherein the second pesticide active is in solid particulate form;
wherein the suspo-emulsion comprises hydrophobic droplets of the first pesticide active having a mean volume diameter of less than about 5 microns, and the suspo-emulsion comprises solid particles of the second pesticide active having a mean volume diameter of less than about 5 microns.
